(19) United States
(12) Patent Application Publication
(10) Pub. No.: US 2010/0059723 A1
(43) Pub. Date: Mar. 11, 2010

(54) BULK THERMOELECTRIC MATERIAL AND THERMOELECTRIC DEVICE INCLUDING THE SAME

(75) Inventors: Sang-mock LEE, Yongin-si (KR); Eun-sung LEE, Seoul (KR); Kyu-hyoung LEE, Yongin-si (KR); Il-ho KIM, Chungju-si (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); Chungju National University Industry-Academic Cooperation Foundation, Chungju-si (KR)

(21) Appl. No.: 12/554,206

(22) Filed: Sep. 4, 2009

(30) Foreign Application Priority Data
Sep. 5, 2008 (KR) 10-2008-0087859

(51) Int. Cl. H01B 1/08; H01B 1/02

(52) U.S. Cl. 252/520.2; 252/518.1; 252/521.3

(57) ABSTRACT

A bulk thermoelectric material includes a matrix, the matrix including a crystalline thermoelectric material; and metal oxide particles disposed in the matrix at a grain boundary or within a crystal structure of the crystalline thermoelectric material.

### CROSS-REFERENCE TO RELATED APPLICATIONS

This application claims priority to Korean Patent Application No. 10-2008-0087859, filed on Sep. 5, 2008, and all the benefits accruing therefrom under 35 U.S.C. §119, the contents of which in its entirety are herein incorporated by reference.

### BACKGROUND

1. Field

One or more embodiments relate to a bulk thermoelectric material with an improved figure of merit.

2. Description of the Related Art

The thermoelectric effect is a reversible and direct method of energy conversion whereby a temperature gradient may be converted into electricity, and occurs by transfer of electrons and holes in a material. The thermoelectric effect encompasses two effects, the Peltier effect and the Seebeck effect. The Peltier effect is applicable to refrigeration and uses a temperature difference between ends of a thermoelectric material, the temperature difference created by externally supplied electric current. The Seebeck effect is applicable to power generation, and uses an electromotive force generated from a temperature difference between ends of a material. It is desirable to use the thermoelectric effect in applications that cannot be readily addressed by commercially available refrigerant gas-compression type systems, such as active refrigeration systems, which may be designed to address heat generation in electronic devices, or precision temperature control systems, such as those used in DNA devices. Thermoelectric cooling is an environmentally friendly method of refrigeration, which does not use a refrigerant gas, which may cause environmental harm, causes no vibration and generates little if any noise. Thus it is desirable to have a thermoelectric cooling material having high efficiency because such thermoelectric materials can be used in a variety of refrigeration applications, such as refrigerators or air conditioners. In addition, a thermoelectric material may used to generate power where heat is generated, such as in a vehicle engine, industrial plants and the like. Thermoelectric power generation systems have already been used in space probes for exploration of Mars or Saturn, which cannot use solar energy. A major obstacle to the application of thermoelectric cooling and power generation is the low energy conversion efficiency. The performance index of a thermoelectric material is referred to as figure of merit. The dimensionless figure of merit ZT includes the figure of merit Z, is dimensionless and is defined by Equation 1 below:

$$ZT = \frac{{S}^{2} σ T}{κ} \qquad Equation ( 1 )$$

wherein Z is the figure of merit, S is the Seebeck coefficient, a is electrical conductivity, T is absolute temperature, and κ is thermal conductivity.

However, the electrical conductivity and the Seebeck coefficient are inversely related for any given figure of merit, thus as one improves the other deteriorates. A thermoelectric material having a ZT value higher than 1 was not commercially available in the middle of 1990s. Therefore, to increase the dimensionless figure of merit ZT, research into a method of increasing the Seebeck coefficient and the electrical conductivity, that is, a power factor S²σ, and decreasing the thermal conductivity have been conducted.

### SUMMARY

One or more embodiments include a bulk thermoelectric material having a structure that does not interfere with electron transfer and can scatter phonons.

One or more embodiments include a thermoelectric device including the bulk thermoelectric material.

Additional aspects will be set forth in part in the description which follows.

To achieve the above and/or other aspects, advantages or features, one or more embodiments includes a bulk thermoelectric material including: a matrix, the matrix including a crystalline thermoelectric material; and metal oxide particles disposed in the matrix at a grain boundary or within a crystal structure of the crystalline thermoelectric material.

A bond strength between a metal atom and an oxygen atom in the metal oxide particles may be greater than a bond strength between atoms in the crystal structure of the crystalline thermoelectric material.

The crystalline thermoelectric material may include at least one element selected from the group consisting of bismuth, antimony, tellurium and selenium.

The crystalline thermoelectric material may have a composition represented by Formula 1:

A₂B₃ (1)

wherein A is at least one of Bi and Sb, and B is at least one of Te and Se.

The crystalline thermoelectric material may have a nano-structure.

A difference between an average particle diameter of the metal oxide particles and a mean free path of phonons may be in the range of 0 to about 7 nanometers, and the average particle diameter of the metal oxide particles may be in the range of about 1 nanometer to about 50 nanometers.

The metal oxide particles may include at least one metal oxide selected from the group consisting of TiO₂, SiO₂, Al₂O₃ and ZrO₂.

The metal oxide particles may be contained in an amount in the range of about 0.5 volume percent to about 15 volume percent based on the total volume of the thermoelectric material.

The metal oxide particles may be spherical.

To achieve the above and/or other aspects, one or more embodiments may include a thermoelectric device including the bulk thermoelectric material.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic diagram of an exemplary embodiment of a thermoelectric material having a phonon-blocking electron-transmitting structure;

FIG. 2 is a diagram of an exemplary embodiment of a thermoelectric material having a phonon-blocking electron-transmitting structure;

FIG. 3A is a perspective view of an exemplary embodiment of an active cooling device;

FIG. 3B is a schematic diagram showing atoms, electrons and holes in an exemplary embodiment of a thermoelectric material;

FIG. 4 is a diagram of an exemplary embodiment of a power generation device using a temperature difference;

FIG. 5 is a graph showing results of thermal conductivity measurement, according to Experimental Example 1; and

FIG. 6 is a graph showing results of dimensionless figure of merit ZT measurement according to Experimental Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

As used herein, the term “and/or” includes any and all combinations of one or more of the associated listed items. It will be understood that, although the terms first, second, third, etc., can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments of the invention.

Spatially relative terms, such as “below,” “lower,” “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device can be otherwise oriented (rotated 90 degrees or at other orientations) and the spatially relative descriptors used herein interpreted accordingly.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

To increase the dimensionless figure of merit ZT of a thermoelectric material, as illustrated in FIG. 1, a structure that scatters phonons 100 and does not scatter carriers 110, that is, a phonon-blocking electron-transmitting structure, is disclosed.

In an embodiment, a method of increasing the dimensionless figure of merit ZT includes a method of increasing the figure of merit of a thin-film thermoelectric material by selecting a property and a size of a grain boundary of the thermoelectric material to cause scattering of phonons at the grain boundary. However, since the thin-film thermoelectric material is prepared using physical deposition, for example, a thickness of the thermoelectric material is limited to a maximum of several micrometers. Thus, it is almost impossible to maintain heat generation in the direction of the thickness of a desired film, that is, a temperature difference in an actual application. Also, manufacturing costs may be very high. Therefore, use of the thin-film thermoelectric material may be limited in applications other than micro-cooling.

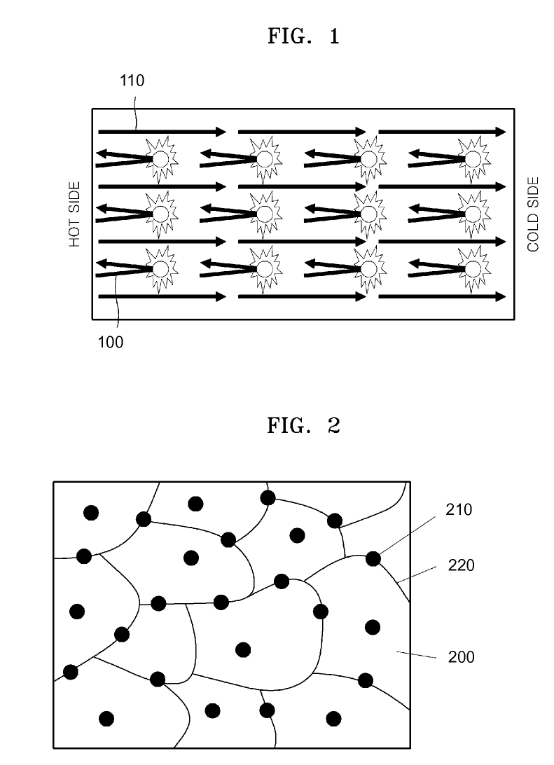

A bulk thermoelectric material according to an embodiment includes, as illustrated in FIG. 2, a matrix comprising a crystalline thermoelectric material 200 and metal oxide particles 210 disposed in the matrix at a grain boundary 220 or within a crystal structure of the thermoelectric material. By metal oxide particles disposed in the matrix at a grain boundary or within a crystal structure of the crystalline thermoelectric material it is meant that the metal oxide particles are physically connected to a crystal structure of the thermoelectric material. That is, the metal oxide particles are bound to the thermoelectric material by, mainly, physical bonding, as opposed to an entirely chemical bonding structure, which may be obtained by substituting a metal atom in the crystal structure of the thermoelectric material with a metal of the metal oxide.

Metal oxide particles having a selected size are independently introduced in the thermoelectric material, and thus free movement of phonons is inhibited, resulting in a reduction in thermal conductivity. Thus, the phonon-blocking electron-transmitting structure can be formed in a bulk thermoelectric device with a volume between about 1 cubic millimeter (“mm³”) and about 100 cubic centimeters (“cm³”), specifically between about 10 mm³ and about 10 cm³, more specifically about 1 cm³. Therefore, a dimensionless figure of merit ZT of the thermoelectric material may be significantly increased by maintaining the electrical conductivity and the Seebeck coefficient, that is, the power factor, to a level similar to the existing level and decreasing the thermal conductivity. Since the thermoelectric material is in bulk, a manufacturing process is simple, manufacturing costs are low, processing efficiency is high, application to a large area is economical, it is feasible to control a size of crystals of the thermoelectric material, and usability thereof is high.

The metal oxide particles may be introduced into a crystal structure of the thermoelectric material or at a grain boundary of the matrix. In an embodiment, a grain boundary is an interface between crystals, thus the metal oxide can be introduced at a crystal interface, which may be an interface between crystals. While not wanting to be bound by theory, in an embodiment, the metal oxide particles are introduced into a grain boundary and the movement of phonons is believed to be predominantly affected at a grain boundary.

In addition, the crystal structure of the thermoelectric material is stable in spite of the introduction of the metal oxide particles, and thus a reduction in the figure of merit of thermoelectric material due to a physical or chemical modification thereof may be prevented or effectively eliminated. Since the metal oxide particles are highly stable, reactivity with other elements is low, and in particular, stability of the metal oxide particles against air and moisture is very high. Thus, side effects caused by an introduction of foreign particles into the thermoelectric material, for example, modification of the crystal structure caused by reacting the foreign particles with an atom of the thermoelectric material, or formation of impurities by reacting the foreign particles with air or moisture, may be reduced or effectively prevented.

In addition, a bond strength between a metal and oxygen in the metal oxide particles may be greater than a bond strength between atoms in the crystal structure of the thermoelectric material. When the bulk thermoelectric material is prepared by alloying the metal oxide particles with the thermoelectric material, bonds between the metal and oxygen in the metal oxide particles are difficult to break, and thus the metal oxide particles are not introduced into the crystal structure of the thermoelectric material and exist independently. As a result, the introduction of a heteroelement may not cause modification of a crystal lattice and may decrease a concentration of carriers, and thus may improve phonon scattering.

In addition, an average particle diameter of the metal oxide particles may be similar to a mean free path of phonons. For example, a difference between the average particle diameter of the metal oxide particles and the mean free path of phonons may be in the range of about 0 nanometers (“nm”) and about 7 nm, specifically between about 1 nm and about 6 nm, more specifically about 3 nm. The term “mean free path” as used herein refers to the average distance that a particle, such as a molecule, can freely travel without colliding with another particle, and the mean free path of phonons refers to a mean free path of phonons in the bulk thermoelectric material, not taking into consideration the introduction of the metal oxide particles. The size of the mean free path of phonons varies according to the type and crystal shape of the thermoelectric material, and may be in the range of about 1 nm and 100 nm, specifically between about 3 nanometers and about 50 nanometers, more specifically between about 10 nm and about 25 nm.

The average particle diameter of the metal oxide particles may be within a range that does not interfere with the movement of carriers. For example, in a Bi—Te-based thermoelectric material including carriers with a mean free path between about 1 nm and 1000 nm, specifically between about 100 nanometers and about 800 nanometers, more specifically between about 200 nm and about 600 nm, if the average particle diameter of the metal oxide particles is excessively large, the carriers are scattered, and thus the electrical conductivity may decrease. In addition, if the average particle diameter of the metal oxide particles is excessively large, the effect of phonon scattering, at a given volume of the metal oxide particles, may be relatively low. Thus, the average particle diameter of the metal oxide particles may be within a range that does not interfere with the movement of the carriers, for example, in the range of about 1 nm and about 50 nm, specifically in the range of about 2 and about 30 nm, more specifically in the range of about 5 and about 15 nm.

The metal oxide particles may comprise one oxide or a plurality of oxides, and may comprise at least one metal oxide selected from the group consisting of TiO₂, SiO₂, Al₂O₃ and ZrO₂. In an embodiment, the metal oxide may consist of TiO₂.

The amount of metal oxide particles added is not particularly limited. However, if the amount of metal oxide particles is excessively large, the metal oxide particles agglomerate with each other, thereby interfering with the movement of carriers. On the other hand, if the amount of metal oxide particles is excessively low, it is difficult to obtain a desired effect of phonon scattering. The amount of metal oxide particles may be in the range of about 0.5 volume percent (“vol %”) and about 15 vol %, specifically between about 1 vol % and about 10 vol %, more specifically in the range of about 1 vol % and about 5 vol % based on the total volume of the thermoelectric material.

In addition, the metal oxide particles may have a variety of types, and may be spherical, taking into consideration the convenience of manufacturing processes and a degree of phonon scattering, but is not limited thereto. In an embodiment, the metal oxide particles may be surface-treated in order to prevent or substantially eliminate agglomeration between the metal oxide particles.

The bulk thermoelectric material comprises a matrix, the matrix comprising a thermoelectric material. In an embodiment the thermoelectric material is crystalline, and may comprise at least one element selected from the group consisting of bismuth, antimony, tellurium, selenium and the like. In another embodiment, the thermoelectric material consists essentially of at least one element selected from the group consisting of bismuth, antimony, tellurium, selenium and the like. In another embodiment, the thermoelectric material consists of at least one element selected from the group consisting of bismuth, antimony, tellurium and selenium.

For example, the thermoelectric material may have a composition represented by Formula 1:

A₂B₃ (1)

wherein A is at least one of Bi and Sb, and B is at least one of Te and Se. When a Bi—Te-based thermoelectric material is used, the thermoelectric material has excellent thermoelectric performance at room temperature, and thus may be used for control of heat generation in highly integrated devices or in sensors.

In the thermoelectric material, when the metal oxide particles are introduced into a grain boundary of the matrix, the smaller the size of the crystal of the thermoelectric material, the more uniform a distribution of the metal oxide particles and the greater the effect of phonon scattering. The thermoelectric material may have a nano-structure. The term “nano-structure” as used herein means that crystal particles of the thermoelectric material have a nano-sized structure, and the term “nano” indicates a size between about 1 nm and about 900 nm, specifically between about 3 nm and about 600 nm, more specifically between about 5 nm and about 100 nm.

According to another embodiment, there is provided a method of preparing the bulk thermoelectric material including: preparing a thermoelectric material powder for forming a matrix comprising the themoelectric material in a sintering process; mixing the matrix with metal oxide particles using a dry mixing method; and sintering the resulting mixture.

The preparing of the thermoelectric material powder is not particularly limited as long as a matrix comprising the thermoelectric material can be formed in the sintering process, and may be performed by mechanical alloying, taking into consideration the convenience of manufacturing processes and a nano-crystalline structure.

In an embodiment, mechanical alloying is a method of alloying whereby a raw powder and steel balls are added to a jar comprising cemented carbide materials, and the mixture is rotated so that the steel balls mechanically impact the raw powder. Examples of the mechanical alloying may include, but are not limited to, vibration ball milling, rotation ball milling, planetary ball milling, attrition milling, bulk mechanical alloying or the like.

In addition, the mixing of the thermoelectric material powder with metal oxide particles may be performed using a dry method, and may be performed using a method selected from the group consisting of ball mill milling, planetary ball milling, attrition milling, specs milling and jet milling, for example.

In addition, the sintering of the resulting mixture may be performed using a sintering method that is commercially available. The mixture of the thermoelectric material powder and the metal oxide particles may be spark plasma sintered after the mixture is added to a mold. When the spark plasma sintering process is used, the sintering process can be performed for a period of time between about 1 second and about 1 hour, specifically between about 10 seconds and about 1 minute. Thus, crystallographic orientation is improved, and achieving desired compaction and control are practicable. As a result, a thermoelectric material with excellent mechanical strength can be prepared.

When a thermoelectric material comprising a nano-structure or nano-sized metal oxide particles is prepared by spark plasma sintering, the thermoelectric material may be, in bulk, in a state in which an initial nano-structure or nano-size particles or crystallites are maintained.

The spark plasma sintering process may be performed, for example, by introducing a pulverized raw powder into a mold, preparing the mold in a vacuum using a vacuum pump, introducing a gas into the container to apply a pressure into the mold and plasma-treating the raw powder in a plasma zone at a center portion of the mold.

The gas may be Ar, H₂, or O₂ or the like but is not limited thereto.

In the plasma-treating process, if a pressure in a chamber is too high or low, it may be difficult to generate or treat using a plasma. Thus, the plasma-treating process may be performed at a pressure in the range of about 50 mega-Pascals (“MPa”) and about 100 MPa, specifically between about 60 MPa and about 90 MPa, more specifically between about 70 MPa and about 80 MPa. In addition, if a plasma treatment time is too short or a heating rate is too slow, it may be difficult to fully perform the plasma-treating process. Thus, the plasma-treating process may be performed at a temperature in the range of about 200° C. and about 600° C., specifically between about 300° C. and about 500° C., more specifically about 400° C. at a heating rate between about 1° C. per minute and about 100° C. per minute, specifically about 50° C. per minute for a time between about 1 second and about 100 minutes, specifically between about 1 minute and about 10 minutes, specifically about 5 minutes.

According to another embodiment, there is provided a thermoelectric device including the thermoelectric material.

The thermoelectric device may be a p-type thermoelectric device or an n-type thermoelectric device.

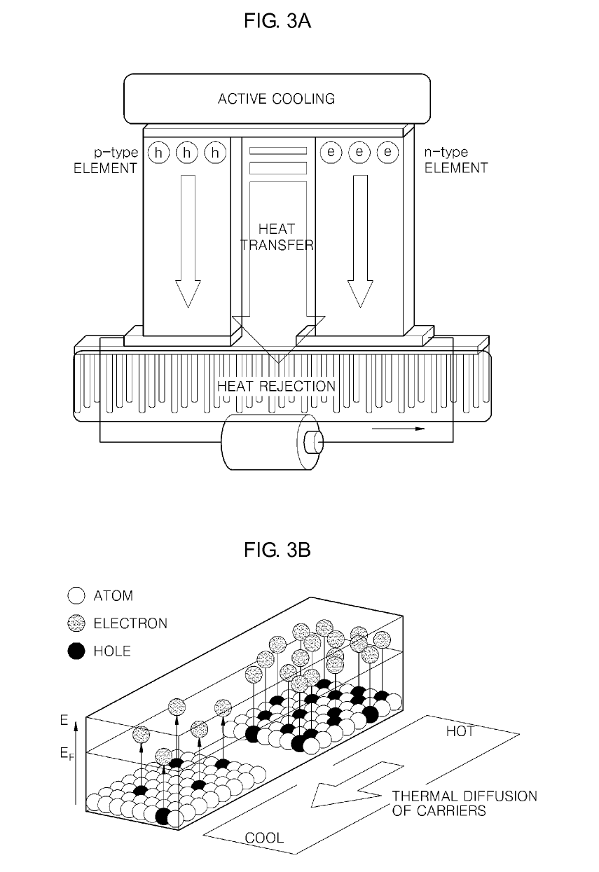

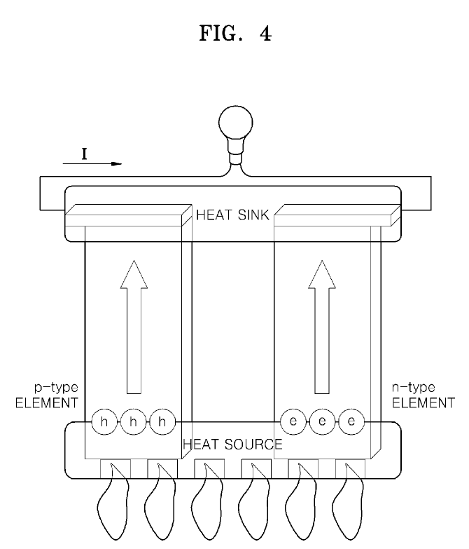

In addition, the thermoelectric device may be in combination with an electrode, and may be, as illustrated in FIG. 3A, a device that can provide cooling upon introduction of electric current, or a device that can provide power generation upon application of a temperature difference, as illustrated in FIG. 4. Also, shown in FIG. 3B is a schematic diagram showing atoms, electrons and holes in an exemplary embodiment of a thermoelectric material.

For example, the thermoelectric device may be a thermoelectric cooling system or a thermoelectric power generation system. Examples of the thermoelectric cooling system may include, but are not limited to, a micro cooling system, a commonly-used cooling device, an air handing unit and a waste heat power generation system. The configuration and manufacturing method of the thermoelectric cooling system are well known in the art, and thus a detailed description thereof is not provided herein.

Hereinafter, one or more embodiments will be described in further detail with reference to the following examples. These examples are for illustrative purposes only and are not intended to limit the scope of the embodiments.

### Example 1

1-1. Preparation of Bi_{0.5}Sb_{1.5}Te₃ Powder

A p-type Bi_{0.5}Sb_{1.5}Te₃ powder, which is a thermoelectric material for a matrix, was prepared by attrition milling. Raw material elements, such as Bi, Sb, and Te and steel balls each having a diameter of 5 millimeters (“mm”) at a weight ratio of 1:20 were added to a jar comprising cemented carbide, and Ar gas was added to the jar in order to prevent an oxidation of the raw material. An impeller made of cemented carbide was rotated at 500 revolutions per minute (“rpm”) inside the jar, and cooling water was circulated outside the jar in order to prevent the oxidation of the raw material caused by heat generated when the impeller was rotated.

1-2. Preparation of Mixture

The Bi_{0.5}Sb_{1.5}Te₃ powder prepared in 1-1 above and 3 vol % of TiO₂ nano-powder comprising TiO₂ nano-particles having an average particle diameter of 7 nm were mixed by dry ball milling.

1-3. Preparation of Thermoelectric Material and Thermoelectric Device

The mixed powder prepared in 1-2 above was added to a mold comprising cemented carbide. Then, plasma sintering was performed on the mixed powder in vacuum (10⁻³ torr or less) at 400° C. at 70 MPa and the resulting material was hot pressed to prepare a thermoelectric material and a thermoelectric device including the thermoelectric material.

### Example 2

A thermoelectric material and a thermoelectric device were prepared in the same manner as in Example 1-2, except that 1 vol % and 5 vol % of TiO₂ nano-powder were respectively used instead of 3 vol % of TiO₂ nano-powder.

### Example 3

A thermoelectric material and a thermoelectric device were prepared in the same manner as in Example 1-2, except that a mixed nano-powder of TiO₂, SiO₂, Al₂O₃, and ZrO₂ was used instead of the TiO₂ nano-powder.

### Example 4

A thermoelectric material ingot comprising Co and Sb was prepared using a melting method, and the thermoelectric material ingot was attrition milled to prepare a thermoelectric material powder.

The thermoelectric material powder was mixed with 1 vol %, 3 vol %, 5 vol %, 7 vol %, 10 vol % or 15 vol % of TiO₂, SiO₂, Al₂O₃ or ZrO₂ powder comprising metal oxide particles having an average particle diameter of 1 nm to 50 nm using the same method as in Example 1-2 above to prepare to prepare 24 samples. Then, using the same method as in Example 1-3, a thermoelectric material was prepared from each sample and a thermoelectric device prepared from each thermoelectric material.

### Example 5

A thermoelectric material and a thermoelectric device were prepared in the same manner as in Example 4, except that a thermoelectric material ingot comprising Pb and Te instead of Co and Sb was used.

### Example 6

A thermoelectric material and a thermoelectric device were prepared in the same manner as in Example 4, except that a thermoelectric material ingot comprising Zn and Sb instead of Co and Sb was used.

### Example 7

A thermoelectric material and a thermoelectric device were prepared in the same manner as in Example 4, except that a thermoelectric material ingot comprising Si and Ge instead of Co and Sb was used.

### Comparative Example 1

A p-type Bi_{0.5}Sb_{1.5}Te₃ powder was prepared using the same method as used in Example 1-1, and a thermoelectric material and a thermoelectric device were prepared using the same method as used in Example 1-3.

### Experimental Example 1

Thermal conductivity and the dimensionless figure of merit ZT were measured according to temperature for each of the thermoelectric devices prepared in Example 1 and Comparative Example 1. The results are shown in Table 1 below.

TABLE 1

| | |
|---|---|
| Comparative | |
| Example 1 | Example 1 |

| | Thermal | | Thermal | |
|---|---|---|---|---|
| Temperature | conductivity | | conductivity | |
| (K) | (W m⁻¹ K⁻¹) | ZT | (W m⁻¹ K⁻¹) | ZT |
| 300 | 0.89 | 0.76 | 0.76 | 0.83 |
| 310 | 0.89 | 0.78 | 0.76 | 0.86 |
| 320 | 0.90 | 0.80 | 0.77 | 0.87 |
| 330 | 0.90 | 0.80 | 0.78 | 0.88 |
| 340 | 0.91 | 0.78 | 0.78 | 0.90 |
| 350 | 0.93 | 0.77 | 0.8 | 0.88 |
| 360 | 0.95 | 0.75 | 0.8 | 0.87 |
| 370 | 1.00 | 0.72 | 0.82 | 0.85 |
| 380 | 1.02 | 0.70 | 0.85 | 0.81 |
| 390 | 1.08 | 0.65 | 0.86 | 0.80 |

*K refers to degrees Kelvin; W m⁻¹ K⁻¹ refers to watts per meter-Kelvin.

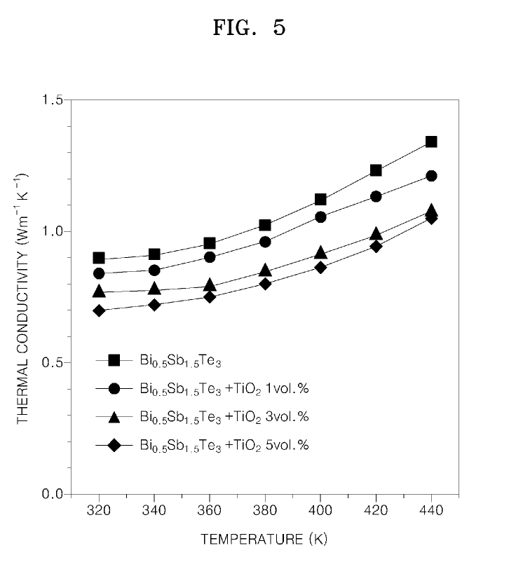

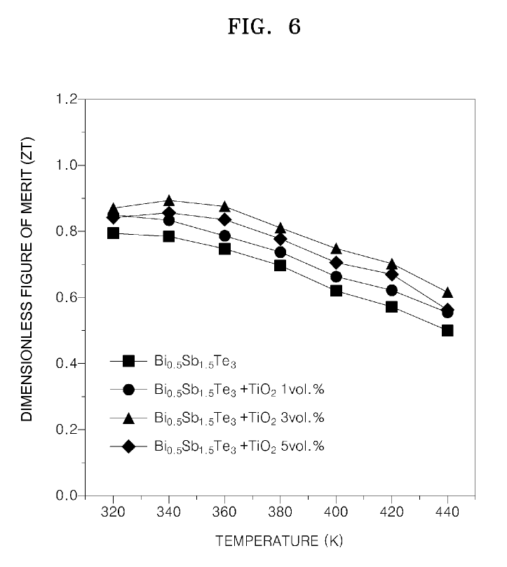

Referring to Table 1 and FIGS. 5 and 6, the thermal conductivity of the thermoelectric material comprising TiO₂ particles of Example 1 is 15 percent (“%”) or more lower than that of the thermoelectric material of Comparative Example 1 over the whole temperature range (300 K to 390 K). In addition, the effect of the reduction in thermal conductivity is greater as the temperature increases, and it is observed that the thermal conductivity of the thermoelectric material of Example 1 is about 20% or more lower than that of the thermoelectric material of Comparative Example 1 at 390 K. In addition, it is observed that the dimensionless figure of merit of the thermoelectric material of Example 1 is about 10% or more greater than that of the thermoelectric material of Comparative Example 1 over the whole temperature range. In particular, the dimensionless figure of merit of the thermoelectric material of Example 1 is 20% or more greater than that of the thermoelectric material of Comparative Example 1 at 390 K. Thus, it is observed that thermoelectric performance effects obtained by the introduction of metal oxide particles are greater at higher temperatures.

As described above, according to one or more of the above embodiments, metal oxide particles are independently introduced into a bulk crystalline thermoelectric material matrix, and thus dimensionless the figure of merit ZT of a bulk thermoelectric material can be improved.

It should be understood that the exemplary embodiments described herein should be considered in a descriptive sense only and not for purposes of limitation. Descriptions of features, advantages or aspects within each embodiment should be considered as available for other features, advantages or aspects in other embodiments.

What is claimed is:

1. A bulk thermoelectric material comprising:
a matrix, the matrix comprising a crystalline thermoelectric material; and
metal oxide particles disposed in the matrix at a grain boundary or within a crystal structure of the crystalline thermoelectric material.

2. The bulk thermoelectric material of claim 1, wherein a bond strength between a metal atom and an oxygen atom in the metal oxide particles is greater than a bond strength between atoms in the crystal structure of the crystalline thermoelectric material.

3. The bulk thermoelectric material of claim 1, wherein the crystalline thermoelectric material comprises at least one element selected from the group consisting of bismuth, antimony, tellurium and selenium.

4. The bulk thermoelectric material of claim 3, wherein the crystalline thermoelectric material has a composition represented by Formula 1:
A₂B₃ (1)
wherein A is at least one of Bi and Sb, and B is at least one of Te and Se.

5. The bulk thermoelectric material of claim 1, wherein the crystalline thermoelectric material has a nano-structure.

6. The bulk thermoelectric material of claim 1, wherein a difference between an average particle diameter of the metal oxide particles and a mean free path of phonons is in the range of 0 to about 7 nanometers.

7. The bulk thermoelectric material of claim 1, wherein an average particle diameter of the metal oxide particles is in the range of about 1 nanometer to about 50 nanometers.

8. The bulk thermoelectric material of claim 1, wherein the metal oxide particles comprise at least one metal oxide selected from the group consisting of TiO₂, SiO₂, Al₂O₃ and ZrO₂.

9. The bulk thermoelectric material of claim 1, wherein the metal oxide particles are contained in an amount in the range of about 0.5 volume percent to about 15 volume percent, based on the total volume of the thermoelectric material.

10. The bulk thermoelectric material of claim 1, wherein the metal oxide particles are spherical.

11. A thermoelectric device comprising the bulk thermoelectric material according to claim 1.
